(19) United States
(12) Patent Application Publication
(10) Pub. No.: US 2015/0314495 A1
(43) Pub. Date: Nov. 5, 2015

(54) POLYESTER COMPOSITIONS

(71) Applicant: LANXESS Deutschland GmbH, Cologne (DE)

(72) Inventors: Timo IMMEL, Dormagen (DE); Jochen ENDTNER, Cologne (DE); Matthias BIENMUELLER, Krefeld (DE)

(21) Appl. No.: 14/702,830

(22) Filed: May 4, 2015

(30) Foreign Application Priority Data
May 5, 2014 (EP) 14166976.2

(51) Int. Cl. B29C 45/00; C08K 3/22; B29C 47/00; C08K 7/14; C08K 3/34; C08K 5/101; C08K 5/5393; C08K 3/38

(52) U.S. Cl. CPC B29C 45/0001; C08K 5/5393; C08K 3/22; C08K 3/38; C08K 7/14; C08K 3/34; C08K 5/101; B29C 47/0004; C08K 2003/2227; C08K 2003/385; B29K 2023/0666

(57) ABSTRACT

Polyester-based compositions with increased glow-wire resistance include at least one filler for improving thermal conductivity, preferably aluminum oxide, boron nitride or aluminium silicate, particularly preferably aluminium silicate, with particular preference aluminium silicate with triclinic-pinacoidal crystal structure. Methods for production of the polymer-based compositions and to products to be produced therefrom are also provided. The products may include products for the electrical and electronics market, preferably devices for domestic use. Also disclosed is the use of aluminium oxide, boron nitride or aluminium silicate, particularly preferably of aluminium silicate, with particular preference of aluminium silicate with triclinic-pinacoidal crystal structure, for improving the glow-wire resistance of products for the electrical and electronics market, preferably of devices for domestic use.

The invention relates to polyester-based compositions with increased glow-wire resistance comprising at least one filler for improving thermal conductivity, preferably aluminium oxide, boron nitride or aluminium silicate, particularly preferably aluminium silicate, with particular preference aluminium silicate with triclinic-pinacoidal crystal structure, to production of these and to products to be produced therefrom for the electrical and electronics market, preferably devices for domestic use, and to the use of aluminium oxide, boron nitride or aluminium silicate, particularly preferably of aluminium silicate, with particular preference of aluminium silicate with triclinic-pinacoidal crystal structure, for improving the glow-wire resistance of products for the electrical and electronics market, preferably of devices for domestic use.

### BACKGROUND OF THE INVENTION

Thermoplastic compositions based on polyesters have inter alia excellent properties in relation to strength, toughness, good surfaces and very good resistance to solvents, and they are therefore used in a wide variety of applications, from the automobile sector extending as far as applications in the electrical and electronics sector. In particular the nonmetallic, insulating materials used for components in devices for domestic use, where said components carry electrical current or are subject to electrical potential, must comply with the requirements of the standard IEC 60335-1 in respect of glow-wire resistance when the distance of the material from the parts carrying electrical current is less than 3 mm.

In the case of devices for domestic use using currents above 0.5 A, where said devices are supervised, the nonmetallic, insulating materials and, respectively, the products manufactured therefrom must achieve a GWFI (Glow Wire Flammability Index=IEC 60695-2-12) of at least 750° C. The GWFI is measured in accordance with IEC 60695-2-12 on a test plaque (disc), and is a measure of the self-extinguishing behaviour of a sample on exposure to a glowing wire. The test sample is pressed for 30 seconds by a force of one newton against a heated glow-wire. The penetration depth of the glow-wire is restricted to 7 mm. The test has been passed if, after removal of the glow-wire, the test sample continues to burn for less than 30 seconds and if a piece of tissue paper underneath the test sample does not ignite.

However, there are alternatively also GWT tests (Glow Wire Temperature Test=IEC 60695-2-11), carried out on the finished component. In the case of devices for domestic use using currents above 0.5 A, where said devices are supervised, the nonmetallic, insulating materials must reach a GWT of at least 750° C.

The requirements here for devices for domestic use where said devices are unsupervised are to achieve a GWFI (Glow Wire Flammability Index=IEC 60695-2-12) of 850° C. and a GWIT (Glow Wire Ignition Temperature=IEC 60695-2-13) of 775° C.

The GWIT in accordance with IEC 60695-2-13 is measured on a test plaque (disc), and is a measure of the ease of ignition of a plastic on exposure by way of example to a glowing wire or to an overheated resistor. No ignition of the test sample is permitted during the entire ignition temperature test. Ignition is defined as burning that continues for more than five seconds. The temperature stated as GWIT is then 25° C. higher than the maximum temperature which does not ignite the plaque. The GWIT is stated by the producer of the materials and is listed on the Underwriters Laboratories (UL) Yellow Card. In an alternative to the GWIT it is also possible to carry out GWT tests (Glow Wire Temperature Test=IEC60695-2-11) on the finished component.

In order to comply with the GWFI and GWIT requirements, polyester-based compositions and thermoplastic moulding compositions based on polyesters are equipped with flame retardants. Halogen-containing flame retardants were preferably used for that purpose. However, these moulding compositions mostly based on brominated flame retardants give rise to environmental concerns, and in particular mostly do not comply with the required GWITs. It is also difficult to comply with other properties that are important in the electrical and electronics sector, for example high tracking resistance values (CTI-A), and also low smoke densities, and preference is nowadays therefore given to use of halogen-free flame retardants in moulding compositions.

WO01/81470 A1, and EP1276813 B1, which derives therefrom, describe flame-retardant polyester compositions comprising polyester resin or a polyester resin blend component, triazine, guanidine, or (iso)cyanurate compounds, zinc sulphide, zinc borate, or boron nitride, optionally nonfibrillating polytetrafluoroethylene, and a phosphorus-containing compound.

JP 2012 229315 describes polyalkylene terephthalate resin compositions comprising inter alia a copolyester based on polybutytene terephthalate using at least 70 mol % of terephthalic acid and 5 to 12 mol % of a hydrogenated dimer acid as acid components, and also boron nitride and/or magnesium silicate, brominated flame retardant, an antimony compound, and a fibrous filler. WO 2006/117087 A1 describes polymer compositions with a nitrogen-based organic flame retardant and with a mould-release agent, and also optionally with a phosphorus-containing flame retardant; these comply with the abovementioned requirements for unsupervised devices for domestic use in accordance with IEC 60695-2-13.

WO 2010/080491 A1 describes mixtures of flame retardants based on a phosphinate salt, and also phosphonate oligomers, polymers, and a melamine derivative. Use of phosphorus-containing flame retardants in PBT (polybutylene terephthalate) gave GWIT values a ≧775° C.

WO 03/018680 A2 presents moulding compositions based on PBT, a nitrogen-containing flame retardant, and also a phosphorus-containing flame retardant; these achieve a GWT of 960° C. in accordance with IEC 695-2-1/2.

A particular disadvantage arising in the use in particular of halogen-free flame retardants is that they have low decomposition temperatures, and that this is associated with restricted processing latitude for moulding compositions comprising halogen-free flame retardants during processing to give products, in particular in injection moulding or in extrusion. Furthermore, phosphorus-containing flame retardants are obtainable only through an energy-intensive production process. There are therefore also environmental reasons for the desirability of avoiding these halogen-free, but phosphorus-containing flame retardants.

### OBJECT

It was therefore an object of the present invention to provide polyester-based compositions for use in products for the electrical and electronics market, preferably for the production of devices for domestic use, which comply with the requirements of the standard IEC 60335-1 even without use of the halogen- or phosphorus-based flame retardants known from the prior art.

Surprisingly, it has been found that polyester compositions comprising at least one component from the group of aluminium oxide, boron nitride, and aluminium silicate comply with the requirements of the standard IEC 60335-1 without any need to use additional flame retardants known from the prior art, and that because these have very good glow-wire resistance together with generous processing latitude, they have excellent suitability for the production of products for the electrical and electronics market, preferably for the production of devices for domestic use.

### INVENTION

The object is achieved by, and the invention therefore provides, compositions comprising
a) at least one polyalkylene terephthalate, preferably polybutylene terephthalate (PBT), polyethylene terephthalate (PET), or a blend of PBT and PET, particularly preferably a blend of PBT and PET, in which the PET content is about 50 to about 99.9% by weight, based on the entirety of all of the polyesters present,
b) at least one component from the group of aluminium oxide, boron nitride, and aluminium silicate, preferably aluminium silicate, particularly preferably aluminium silicate with triclinic-pinacoidal crystal structure, and
c) glass fibres.

For clarification it should be noted that the scope of the present invention encompasses any desired combination of all the definitions and parameters listed hereinafter in general terms or in preferred ranges.

### PREFERRED EMBODIMENTS OF THE INVENTION

The present invention preferably provides compositions comprising
a) about 24.9 to about 89.9% by weight, preferably about 34.9 to about 84.9% by weight, particularly preferably about 44.9 to about 84.9% by weight, of at least one polyalkylene terephthalate, preferably PBT, PET, or a blend of PBT and PET, particularly preferably a blend of PBT and PET, in particular a blend of PBT and PET in which the PET content is about 50 to about 99.9% by weight, based on the entirety of all of the polyesters present,
b) about 10 to about 75% by weight, preferably about 15 to about 65% by weight, particularly preferably about 25 to about 65% by weight, of at least one component from the group of aluminium oxide, boron nitride, and aluminium silicate, preferably aluminium silicate, particularly preferably aluminium silicate with triclinic-pinacoidal crystal structure, and
c) about 0.1 to about 50% by weight, preferably about 10 to about 40% by weight, particularly preferably about 10 to about 30% by weight, of glass fibres,

with the proviso that the sum of all of the percentages by weight is always 100.

The present invention particularly preferably provides compositions comprising
a) about 24.9 to about 54% by weight, preferably about 28 to about 45% by weight, particularly preferably about 32 to about 40% by weight, of polybutylene terephthalate or polyethylene terephthalate, or a blend of PBT and PET, particularly preferably a blend of PBT and PET, in particular a blend of PBT and PET in which the PET content is about 50 to about 99.9% by weight, based on the entirety of all of the polyesters present,
b) about 21 to about 75% by weight, preferably about 30 to about 70% by weight, particularly preferably about 40 to about 65% by weight, of at least one component from the group of aluminium oxide, boron nitride, and aluminium silicate, preferably aluminium silicate, particularly preferably aluminium silicate with triclinic-pinacoidal crystal structure, and
c) about 0.1 to about 50% by weight, preferably about 2 to about 40% by weight, particularly preferably about 3 to about 30% by weight, of glass fibres,

with the proviso that the sum of all of the percentages by weight is always 100.

The compositions of the invention are prepared for further use via mixing the components a) to c) to be used as starting materials in at least one mixer. This gives, as intermediates, moulding compositions based on the compositions of the invention. These moulding compositions can either be composed exclusively of components a) to c) or else comprise other components in addition to components a) to c). In this case, the quantities of components a) to c) are to be altered within the quantitative ranges stated in such a way that the sum of all of the percentages by weight is always 100.

In one embodiment, the compositions of the invention also comprise, in addition to components a) to c),
d) about 0.01 to about 5% by weight, preferably about 0.05 to about 4% by weight, particularly preferably about 0.1 to about 3% by weight, in each case based on the entire composition, of at least one phosphite stabilizer, where the quantities of components a), b), c) are reduced to an extent such that the sum of all of the percentages by weight is always 100.

In one embodiment, the compositions of the invention also comprise, in addition to components a) to d), or instead of d),
e) about 0.01 to about 10% by weight, based on the entire composition, of at least one additive for improving flowability, also termed flow auxiliary, flow agent, flow aid or internal lubricant, where the quantities of the other components are reduced to an extent such that the sum of all of the percentages by weight is always 100.

In one embodiment, the compositions of the invention also comprise, in addition to components a) to d) or instead of d) and/or e)
f) about 0.01 to about 10% by weight, preferably about 0.01 to about 5% by weight, based on the entire composition, of talc powder, preferably microcrystalline talc powder, where the quantities of the other components are reduced to an extent such that the sum of all of the percentages by weight is always 100.

In one embodiment, the compositions of the invention also comprise, in addition to components a) to e) or instead of components d) and/or e) and/or f),
g) about 0.01 to about 15% by weight, preferably about 0.01 to about 10% by weight, particularly preferably about 0.01 to about 5% by weight, based on the entire composition, of at least one mould-release agent, where the quantities of the other components are reduced to an extent such that the sum of all of the percentages by weight is always 100.

In one embodiment, the compositions of the invention also comprise, in addition to components a) to g) or instead of components d) and/or e) and/or f) and/or g),
h) about 0.01 to about 45% by weight, preferably about 0.01 to about 30% by weight, particularly preferably about 0.01 to about 15% by weight, based on the entire composition, of at least one other additive different from components c) to g), where the quantities of the other components are reduced to an extent such that the sum of all of the percentages by weight is always 100.

According to the invention it is advantageous if component b) used comprises aluminium oxide, aluminium silicate or boron nitride, the latter in combination with titanium dioxide as component h).

It is preferable to use aluminium oxide as component b).

An alternatively preferred embodiment uses, instead of aluminium oxide or aluminium silicate, boron nitride in combination with titanium dioxide.

As per the above, the following possible combinations of components A), B), C), D), E), F), G), and H) may be provided. For simplification, (X) will represent the three components ABC, such that possible combinations may include:
1 additional component XD, XE, XF, XG, XH;
2 additional components: XDE, XDF, XDH, XEG, XFG, XDG, XEF, XEH, XFH, XGH;
3 additional components: XDEF, XDFG, XDEG, XEFG, XDEH, XEGH, XFGH, XDFH, XDGH, XEFH;
4 additional components: XDEFG, XDEFH, XDEGH, XEFGH, XDFGH; and
5 additional components: XDEFGH.

Component a)

According to the invention, component a) is at least one polyalkylene terephthalate, preferably at least polybutylene terephthalate (PBT), polyethylene terephthalate (PET) or a blend of PBT and PET, in particular a blend of PBT and PET in which the PET content, based on the entirety of all of the polyesters present, is about 50 to about 99.9% by weight. According to the invention it is preferable that component a) is polybutytene terephthalate (PBT) or polyethylene terephthalate (PET) or a blend of PBT and PET, in particular a blend of PBT and PET in which the PET content, based on the entirety of all of the polyesters present, is about 50 to about 99.9% by weight.

The polyalkylene terephthalates PBT and, respectively, PET to be used in accordance with the invention are reaction products of aromatic dicarboxylic acids or reactive derivatives thereof, preferably dimethyl esters or anhydrides, and the appropriate aliphatic diols. They can be produced by known methods from terephthalic acid (or reactive derivatives thereof) and the respective aliphatic diols having 4 and, respectively, 2 C atoms (Kunststoff-Handbuch, Bd. VIII [Plastics handbook, Volume VIII], pp. 695-743 if, Kar-Hanser-Verlag, Munich 973).

PET to be used with preference as polyester comprises at least about 80 mol %, preferably at least about 90 mol %, based on dicarboxylic acid, of terephthalic acid moieties and at least about 80 mol %, preferably at least about 90 mol %, based on the diol component, of ethylene glycol moieties.

PBT to be used with preference as polyester comprises at least about 80 mol %, preferably at least about 90 mol %, based on dicarboxylic acid, of terephthalic acid moieties and at least about 80 mol %, preferably at least 90 mol %, based on the diol component, of 1,4-butanediol moieties. The abovementioned polyesters PBT and PET that are to be used with preference can comprise, alongside ethylene glycol moieties and, respectively, 1,4-butanediol moieties, up to about 20 mol % of other aliphatic diols having 3 to 12 C atoms or cycloaliphatic diols having 6 to 21 C atoms. Preference is given to moieties of 1,3-propanediol, 2-ethyl-1,3-propanediol, neopentyl glycol, 1,5-pentanediol, 1,6-hexanediol, 3-methyl-2,4-pentanediol, 2-methyl-2,4-pentanediol, 2,2,4-trimethyl-1,3-pentanediol, 1,6,2-ethyl-1,3-hexanediol, 2,2-diethyl-1,3-propanediol, 2,5-hexanediol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)propane or 2,2-bis(4-hydroxypropoxyphenyl)propane (DE-A 24 07 674 (=U.S. Pat. No. 4,035,958), DE-A 24 07 776, DE-A 27 15 932 (=U.S. Pat. No. 4,176,224)).

In one embodiment, the abovementioned polyesters that are to be used with preference can be branched via incorporation of relatively small quantities of tri- or tetrahydric alcohols or tri- or tetrabasic carboxylic acids, for example those described in DE-A 19 00 270 (=U.S. Pat. No. 3,692,744). Preferred branching agents are trimesic acid, trimellitic acid, trimethylolethane and trimethylolpropane and pentaerythritol.

It is preferable that the intrinsic viscosity of the abovementioned polyesters that are to be used with preference according to the invention is about 30 cm³/g to about 150 cm³/g, particularly about 40 cm³/g to about 130 cm³/g, in particular about 50 cm³/g to about 110 cm³/g, measured in each case in phenol/o-dichlorobenzene (1:1 parts by weight) at 25° C. with an Ubbelohde viscometer.

The intrinsic viscosity [η] is also termed limiting viscosity number or Staudinger index, since firstly it is a material-dependent constant and secondly it is related to molecular weight. It indicates how the viscosity of the solvent is influenced by the dissolved substance. Intrinsic viscosity is determined by using the following definition:

$$[ η ] = {lim}_{c -> 0} \frac{{η}_{sp}}{c} = {lim}_{c -> 0} \frac{1}{c} ln ( \frac{η}{{η}_{0}} )$$

where c is the concentration of the dissolved substance in g/ml, η₀ is the viscosity of the pure solvent and

$${η}_{sp} = \frac{η}{{η}_{0}} - 1$$

is the specific viscosity.

If a blend of PET and PBT is used, preference is given to a blend in which the PET content, based on the entirety of all of the polyesters present in component a), is about 50 to 99.9% by weight.

Component b)

It is preferable that the aluminium oxide and the boron nitride are used within the form of fine needles, platelets, spheres or irregularly shaped particles within component b). Preferred particle sizes of the aluminium oxide and of the boron nitride are about 0.1 to about 300 μm, particularly about 0.5 to about 100 μm. It is preferable that the thermal conductivity of the aluminium oxide and, respectively, the boron nitride is about 10 to about 400 W/mK, particularly about 30 to about 250 W/mK. A suitable example of aluminium oxide is Martoxid® MPS-2 [CAS No. 1344-28-1] from Martinswerk GmbH, Bergheim, Germany. The boron nitrides [CAS No. 10043-11-5] to be used as component b) are obtainable by way of example as BORONID® from ESK Ceramics GmbH & Co. KG, Kempten, Germany, a subsidiary of 3M, St. Paul/Minnesota, USA.

Aluminium silicate preferably used is triclinic-pinacoidal aluminium silicate. Kyanite, the mineral preferably to be used for the purposes of the present invention [CAS No. 1302-76-7], is an aluminium silicate that occurs in triclinic-pinacoidal crystalline form with the chemical composition Al₂[OSiO₄]. Kyanite can comprise iron compounds and chromium compounds as impurities. According to the Invention it is preferable that the aluminium silicate or kyanite used comprises less than 1% by weight of impurities, particularly less than 0.5% by weight.

It is preferable to use the aluminium silicate, preferably Al₂[OSiO₄] or kyanite, in the form of a powder. The median particle size do of preferred aluminium silicate powders, preferably Al₂[OSiO₄] or kyanite powders, is at most 500 μm, preferably about 0.1 to about 250 μm, particularly preferably about 0.5 to about 150 μm, very particularly preferably about 0.5 to about 70 μm (in accordance with ASTM D1921-89, Method A), thus ensuring fine dispersion in the moulding compositions obtainable from the compositions of the invention and in the products to be produced therefrom.

The Al₂[OSiO₄] particles or kyanite particles to be used with preference according to the invention can have various shapes, described via the aspect ratio. Preference is given to use of Al₂[OSiO₄] particles or kyanite particles with an aspect ratio about 1 to about 100, particularly about 1 to about 30, very particularly about 1 to about 10.

The aluminium silicate particles to be used according to the invention, preferably Al₂[OSiO₄] particles or kyanite particles, can be used with and/or without surface modification. The expression surface modification denotes organic coupling agents which are intended to improve the binding of the particles to the thermoplastic matrix. Surface modification preferably used comprises aminosilanes or epoxysilanes. In one particularly preferred embodiment, the aluminium silicate particles to be used according to the invention, preferably Al₂[OSiO₄] particles, or kyanite particles, are used without surface modification. An example of a supplier of kyanite is Quarzwerke GmbH, Frechen, which markets kyanite Al₂[OSiO₄] as Silatherm®.

The aluminium oxide, boron nitride and aluminium silicate can respectively be used individually or as a mixture. According to the invention, preference is given to use of mixtures of boron nitride and aluminium silicate. In particular, it is preferable to use aluminium silicate alone.

Component c)

According to “http://de.wikipeda.org/wiki/Faser-Kunststoff-Verbund”, a distinction is drawn between chopped fibres, also termed short fibres, with length about 0.1 to about 1 mm, long fibres with length about 1 to about 50 mm and continuous-filament fibres with length L>50 mm. Short fibres are used in injection-moulding technology and can be processed directly with an extruder. Long fibres can likewise also be used in extruders. They are widely used in spray lay-up. Long fibres are frequently admixed as filler with thermosets. Continuous-filament fibres are used in the form of rovings or woven fabric in fibre-reinforced plastics. Products with continuous-filament fibres achieve the highest values for stiffness and strength. Ground glass fibres are moreover available, the length of these after grinding typically being about 70 to about 200 μm.

According to the invention, the expression glass fibres comprises short glass fibres, long glass fibres and continuous-filament glass fibres with the lengths stated above, where the stated lengths are based on initial length, i.e. length prior to any processing.

The processing to give the moulding composition or to give the product can cause the d97 or d50 value of the glass fibres of component c) in the moulding composition or in the product to be smaller than that of the glass fibres originally used: the arithmetic average of the glass fibre length after processing is often about 150 μm to about 300 μm.

The fibre diameter of preferred glass fibres to be used as component c) is about 7 to about 18 μm, particularly preferably about 9 to about 15 μm.

It is preferable according to the invention that component c) used comprises chopped long glass fibres with initial length about 1 to about 50 mm, particularly about 1 to about 10 mm, very particularly about 2 to about 7 mm.

In one preferred embodiment, the glass fibres of component c) are modified with a suitable size system or with a coupling agent or coupling agent system. It is preferable to use a silane-based size system or a silane-based coupling agent.

Particularly preferred silane-based coupling agents for the pretreatment are silane compounds of the general formula (I)

(X—(CH₂)_{q})k-Si—(O—CrH₂ᵣ₊₁)4-k (I)

in which

X is NH₂—, carboxy-, HO— or

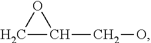

q is an integer 2 to 10, preferably 3 to 4,

r is an integer 1 to 5, preferably 1 to 2, and

k is an integer 1 to 3, preferably 1.

Preferred coupling agents are in particular silane compounds from the group of amnopropyltrimethoxysilane, aminobutyltrimethoxysilane, aminopropyltriethoxysilane, aminobutyltriethoxysilane, and also the corresponding silanes which comprise a glycidyl or carboxy group as substituent X (see formula (I)), where very particular preference is in particular given to carboxy groups.

Quantities of the coupling agent, preferably the silane compounds according to formula (I), used for the modification of the glass fibres to be used as component c) are preferably about 0.05 to about 2% by weight, particularly preferably about 0.25 to about 1.5% by weight and very particularly preferably about 0.5 to about 1% by weight, based in each case on 100% by weight of component c).

According to “http://www.r-g.de/wiki/Glasfasern”, glass fibres are produced by the melt spinning process (processes involving drawing from nozzles, drawing from rods, and nozzles followed by air jets). In the process involving drawing from nozzles, the hot glass composition flows under gravity through hundreds of nozzle apertures in a platinum spinneret. The individual filaments can be drawn at a velocity of 3 to 4 km/minute with no length restriction.

The person skilled in the art classifies glass fibres into various types, some of which are listed here by way of example:
E glass: the most widely used material with optimal price-performance ratio (R&G)
H glass: hollow glass fibres for reduced weight (R&G 160 g/m² and 216 g/m² woven hollow glass fibre fabric)
R and S glass: for relatively stringent mechanical requirements (S2 glass from R&G)
D glass: borosilicate glass for relatively stringent electrical requirements
C glass: with relatively high chemical stability
quartz glass: with high resistance to temperature change.

Other examples are available at “http//de.wikipedia.org/wiki/Glasfaser”. E glass fibres have achieved the greatest importance for plastics reinforcement. E stands for electrical, since this glass was originally used mainly in the electrical industry. E glass is produced by producing glass melts from pure quartz with additions of limestone, kaolin and boric acid. They comprise various quantities of a variety of metal oxides, alongside silicon dioxide. The properties of the products are determined by the composition. According to the invention, preference is given to at least one type of glass fibres from the group of E glass, H glass, R and S glass, D glass, C glass and quartz glass, particular preference being given to glass fibres made of E glass.

Glass fibres made of E glass are the most widely used reinforcement material. Strength properties correspond to those of metals (e.g. aluminium alloys), and the specific weight of laminates here is lower than that of the metals. E glass fibres are incombustible, heat-resistant up to about 400° C. and resistant to most chemicals and to effects of weathering.

Component d)

According to the invention, at least one phosphite stabilizer is used as component d). It is preferable to use at least one phosphite stabilizer from the group of tris(2,4-di-tert-butylphenyl)phosphite (Irgafos® 168, BASF SE, CAS 31570-04-4), bis(2,4-di-tert-butylphenyl)pentaerythritol diphosphite (Ultranox® 626, Chemtura, CAS 26741-53-7), bis(2,6-di-tert-butyl-4-methylphenyl)pentaerythritol diphosphite (ADK Stab PEP-36, Adeka, CAS 80693-00-1), bis(2,4-dicumylphenyl)pentaerythritol diphosphite (Doverphos® S-9228, Dover Chemical Corporation, CAS 154862-43-8), tris(nonylphenyl)phosphite (Irgafos® TNPP, BASF SE, CAS 26523-78-4), (2,4,6-tri-tert-butylphenol) 2-butyl-2-ethyl-1,3-propanediol phosphite (Ultranox® 641, Chemtura, CAS 161717-32-4) or Hostanox® P-EPQ.

In particular, it is preferable to use at least Hostanox® P-EPQ [CAS No. 119345-01-6] from Clariant International Ltd., Muttenz, Switzerland as phosphite stabilizer. This comprises tetrakis(2,4-di-tert-butylphenyl) 1,1-biphenyl-4,4′-diylbisphosphonite [CAS No. 38613-77-3], which according to the Invention is in particular to be used with very particular preference as component d).

Component e)

Flow auxiliares used are preferably copolymers of at least one α-olefin with at least one methacrylate or acrylate of an aliphatic alcohol. Particular preference is given here to copolymers where the α-olefin is composed of ethene and/or propene and the methacrylate or acrylate comprises, as alcohol component, linear or branched alkyl groups having about 6 to 20 C atoms. Very particular preference is given to 2-ethylhexyl acrylate. Features of copolymers suitable according to the invention as flow auxiliaries are not only their composition but also their low molecular weight. Accordingly, copolymers suitable for the compositions which are according to the Invention and are to be protected from thermal degradation are especially those with MFI value at least about 100 g/10 min, preferably at least about 150 g/10 min, particularly preferably at least about 300 g/10 min, measured at 190° C. with 2.16 kg load. The MFI or Melt Flow Index serves to characterize the melt flow of a thermoplastic, and is subject to the standards ISO 1133 and ASTM D1238. For the purposes of the present invention, the MFI and all data relating to the MFI are based on, or were measured or determined exclusively in accordance with, ISO 1133 at 190° C. with a test weight of 2.16 kg.

Component f)

According to the invention, talc powder [CAS No. 14807-96-6], preferably microcrystalline talc powder, is used as component f). Talc powder, also termed talc, is a phyllosilicate with chemical composition Mg₃[Si₄O₁₀(OH)₂], which crystallizes as talc 1A in the triclinic crystal system or as talc 2M in the monoclinic crystal system (http://de.wikipedia.org/wik/Talkum). Talc powder to be used according to the invention [CAS No. 14807-96-6] can be purchased by way of example as Mistron® R10 frp, Imerys Talc Group, Toulouse, France (Rio Tinto Group).

Component g)

According to the invention, as least one mould-release agent is used as component g). A preferred mould-release agent is at least one selected from the group of ester wax(es), pentaerythritol tetrastearate (PETS), long-chain fatty acids, salt(s) of long-chain fatty adds, amide derivative(s) of long-chain fatty acids, montan waxes and low-molecular-weight polyethylene wax(es) and low-molecular-weight polypropylene wax(es) and ethylene homopolymer wax(es).

Preferred long-chain fatty acids are stearic acid and behenic acid. Preferred salts of long-chain fatty acids are calcium stearate and zinc stearate. Preferred amide derivative of long-chain fatty acids is ethylenebisstearylamide. Preferred montan waxes are mixtures of straight-chain, saturated carboxylic acids having chain lengths of about 28 to about 32 C atoms.

In particular, it is preferable that mould-release agent used comprises at least one montanic ester of polyhydric alcohols, and particularly at least one ester of straight-chain, unbranched C₂₈-C₃₂ monocarboxylic acids with ethylene glycol or glycerol which can be purchased as Licowax® E [CAS No. 73138-45-1] from Clariant, Muttenz, Switzerland.

Component h)

According to the invention, component h) used can comprise at least one additive differing from components b), c), d), e), f) and g).

Additives of component h) are preferably stabilizers different from component d), in particular UV stabilizers, heat stabilizers, gamma-radiation stabilizers, antistatic agents, flow auxiliaries, flame retardants, elastomer modifiers, fire-protection additives, emulsifiers, nucleating agents, plasticizers, lubricants, dyes or pigments. The additives mentioned and other suitable additives are described by way of example in Gächter, Müller, Kunststoff-Additive [Plastics Additives], 3rd Edition, Hanser-Verlag, Munich, Vienna, 1989 and in Plastics Additives Handbook, 5th Edition, Hanser-Verlag, Munich, 2001. The additives can be used alone or in a mixture or in the form of masterbatches.

Preferred stabilizers used are sterically hindered phenols, hydroquinones, aromatic secondary amines such as diphenylamines, substituted resorcinols, salicylates, benzotriazoles and benzophenones, and also variously substituted members of these groups or a mixture of these.

Dyes and pigments used are preferably zinc sulphide, titanium dioxide, ultramarine blue, iron oxide, carbon black, phthalocyanines, quinacridones, perylenes, nigrosin and anthraquinones.

The average particle size of the titanium dioxide preferably to be used as pigment is in turn preferably about 90 nm to about 2000 nm. The titanium dioxide preferably to be used according to the invention as pigment can be titanium dioxide pigments with fundamental structure produced by the sulphate process (SP) or chloride process (CP), where the said structure is that of anatase and/or rutile, preferably rutile. It is not necessary that the fundamental structure is a stabilized structure, but preference is given to specific stabilization: resulting in the case of a CP-derived fundamental structure from doping with about 0.3 to 3.0% by weight of Al (calculated as Al₂O₃) and an excess of oxygen in the gas phase of at least 2% during the oxidation of titanium tetrachloride to give titanium dioxide; resulting in the case of an SP-derived fundamental structure from doping preferably with Al, Sb, Nb or Zn.

When titanium dioxide is used as white pigment in paints, coatings, plastics, etc., it is known that undesired photocatalytic reactions resulting from UV absorption lead to decomposition of the pigmented material. Titanium dioxide pigments absorb light in the near ultraviolet region here, thus producing electron-hole pairs, which generate highly reactive free radicals on the titanium dioxide surface. In organic media, the resultant free radicals cause binder degradation. According to the invention, it is preferable to reduce the photoactivity of the titanium dioxide by inorganic post-treatment of the same, particularly preferably with oxides of Si and/or Al and/or Zr and/or by using Sn compounds.

It is preferable that the surface of titanium dioxide pigment has a coating of amorphous precipitated oxide hydrates of the compounds SiO₂ and/or Al₂O₃ and/or zirconium oxide. The Al₂O₃ coating facilitates dispersion of the pigment in the polymer matrix, and the SiO₂ coating inhibits charge exchange at the pigment surface and thus prevents polymer degradation.

According to the invention, it is preferable to provide hydrophilic and/or hydrophobic organic coatings to the titanium dioxide, in particular using siloxanes or polyalcohols.

According to the invention, it is in particular preferable that the average particle size of titanium dioxide to be used as pigment is about 90 nm to about 2000 nm, preferably about 200 nm to about 800 nm. Examples of products obtainable commercially are Kronos® 2230, Kronos® 2225 and Kronos® vip7000 from Kronos, Dallas, USA.

Nucleating agent used preferably comprises sodium phenylphosphinate, calcium phenylphosphinate, aluminium oxide or silicon dioxide.

Preferred plasticizers used are dioctyl phthalate, dibenzyl phthalate, butyl benzyl phthalate, hydrocarbon oils or N-(n-butyl)benzenesulphonamide.

Additive to be used as elastomer modifier is preferably one or more graft polymer(s) E of
E.1 about 5 to about 95% by weight, preferably about 30 to about 90% by weight, of at least one vinyl monomer on
E.2 about 95 to about 5% by weight, preferably about 70 to about 10% by weight, of one or more graft bases with glass transition temperatures <10° C., preferably <0° C., particularly preferably <−20° C.

The median particle size (d₅₀ value) of the graft base E.2 is generally about 0.05 to 10 μm, preferably about 0.1 to about 5 μm, particularly preferably about 0.2 to about 1 μm.

Monomers E.1 are preferably mixtures of
E.1.1 about 50 to about 99% by weight of vinylaromatics and/or ring-substituted vinylaromatics, in particular styrene, α-methylstyrene, p-methylstyrene, p-chlorostyrene, and/or (C₁-C₈)-alkyl methacrylate, in particular methyl methacrylate, ethyl methacrylate, and
E.1.2 about 1 to about 50% by weight of vinyl cyanides, in particular acrylonitrile and methacrylonitrile, and/or (C₁-C₈)-alkyl (meth)acrylate, in particular methyl methacrylate, n-butyl acrylate, tert-butyl acrylate, and/or derivatives, in particular anhydrides and imides, of unsaturated carboxylic acids, in particular maleic anhydride and N-phenylmaleimide.

Preferred monomers E.1.1 are those selected from at least one of the monomers styrene, α-methylstyrene and methyl methacrylate, and preferred monomers E.1.2 are those selected from at least one of the monomers acrylonitrile, maleic anhydride, and methyl methacrylate.

Particularly preferred monomers are E.1.1 styrene and E.1.2 acrylonitrile.

Examples of graft bases E.2 suitable for the graft polymers to be used in the elastomer modifiers are, in particular, diene rubbers, EP(D)M rubbers, i.e. rubbers based on ethylene/propylene and if appropriate on dine, and also acrylate rubbers, polyurethane rubbers, silicone rubbers, chloroprene rubbers and ethylene/vinyl acetate rubbers.

Preferred graft bases E.2 are diene rubbers (in particular those based on butadiene, isoprene, etc.) or are a mixture of diene rubbers, or are copolymers of diene rubbers or of a mixture of these with other copolymerizable monomers, in particular in accordance with E.1.1 and E.1.2, with the proviso that the glass transition temperature of component E.2 is <10° C., preferably <0° C., particularly preferably <−10° C.

Pure polybutadiene rubber is particularly preferred as graft base E.2.

Particularly preferred polymers E are ABS polymers (emulsion ABS, bulk ABS and suspension ABS), examples being those described in DE-A 2 035 390 (=U.S. Pat. No. 3,644,574) or in DE-A 2 248 242 (=GB-A 1 409 275) or in Ullmann, Enzyldäpdie der Technischen Chemie [Encyclopedia of Industrial Chemistry], vol. 19 (1980), pp. 280 ft. The gel content of the graft base E.2 is at least 30% by weight, preferably at least 40% by weight (measured in toluene). ABS means acrylonitrile-butadiene-styrene copolymer with CAS number 9003-56-9, and is a synthetic terpolymer of the following three different types of monomer: acrylonitrile, 1,3-butadiene and styrene. It is an amorphous thermoplastic. The quantitative ratios here can vary from about 15 to about 35% of acrylonitrile, from about 5 to about 30% of butadiene and from about 40 to about 60% of styrene.

The elastomer modifiers or graft copolymers E are produced via free-radical polymerization, e.g. via emulsion, suspension, solution or bulk polymerization, in particular via emulsion or bulk polymerization.

Other particularly suitable graft rubbers are ABS polymers which are produced via redox initiation using an initiator system composed of organic hydroperoxide and ascorbic acid according to U.S. Pat. No. 4,937,285.

It is known that the graft monomers are not necessarily entirely grafted onto the graft base during the grafting reaction and therefore products which are obtained via (co)polymerization of the graft monomers in the presence of the graft base and are produced concomitantly during the work-up are also graft polymers E according to the invention.

Suitable acrylate rubbers are those based on graft bases E.2 which are preferably polymers composed of alkyl acrylates, if appropriate with up to about 40% by weight, based on E.2, of other polymerizable, ethylenically unsaturated monomers. Among the preferred polymerizable acrylic esters are C₁-C₈-alkyl esters, preferably methyl, ethyl, butyl, n-octyl and 2-ethylhexyl esters; haloalkyl esters, preferably halo-C₁-C₈-alkyl esters, particularly preferably chloroethyl acrylate, and also mixtures of the said monomers.

Monomers having more than one polymerizable double bond can be copolymerized for crosslinking purposes. Preferred examples of crosslinking monomers are esters of unsaturated monocarboxylic acids having about 3 to about 8 carbon atoms and of unsaturated monohydric alcohols having about 3 to about 12 carbon atoms, or of saturated polyols having about 2 to about 4 OH groups and about 2 to about 20 carbon atoms, e.g. ethylene glycol dimethacrylate, allyl methacrylate; polyunsaturated heterocyclic compounds, preferably trivinyl and triallyl cyanurate; polyfunctional vinyl compounds, preferably di- and trivinylbenzenes; but also triallyl phosphate and diallyl phthalate.

Preferred crosslinking monomers are allyl methacrylate, ethylene glycol dimethacrylate, diallyl phthalate and heterocyclic compounds which have at least 3 ethylenically unsaturated groups.

Particularly preferred crosslinking monomers are the cyclic monomers triallyl cyanurate, triallyl isocyanurate, triacryloylhexahydro-s-triazine, triallybenzenes. The amount of the crosslinked monomers is preferably about 0.02 to about 5% by weight, in particular about 0.05 to about 2% by weight, based on the graft base E.2.

In the case of cyclic crosslinking monomers having at least 3 ethylenically unsaturated groups, it is advantageous to restrict the amount to below 1% by weight of the graft base E.2.

Examples of preferred “other” polymerizable, ethylenically unsaturated monomers which can serve alongside the acrylic esters, if appropriate, for production of the graft base E.2 are, in particular, acrylonitrile, styrene, a-methylstyrene, acrylamides, vinyl C₁-C₆-alkyl ethers, methyl methacrylate, butadiene. Acrylate rubbers preferred as graft base E.2 are emulsion polymers whose gel content is at least 60% by weight.

Other suitable graft bases according to E.2 are silicone rubbers having sites active for grafting purposes, as described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515).

Additives to be used as flame retardants comprise commercially available organic halogen compounds with or without synergists or commercially available halogen-free flame retardants based on organic or inorganic phosphorus compounds different from component d) or comprise organic nitrogen compounds, individually or in a mixture.

Halogen-containing, in particular brominated and chlorinated, compounds that may be mentioned as preferred are ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene and brominated polyphenylene ethers. Suitable phosphorus compounds are the phosphorus compounds according to WO-A 98117720 (=U.S. Pat. No. 6,538,024), preferably metal phosphinates, in particular aluminium phosphinate and zinc phosphinate, metal phosphonates, in particular aluminium phosphonate, calcium phosphonate and zinc phosphonate, and also the corresponding hydrates of the metal phosphonates, and also derivatives of 9,10-dihydro-9-oxa-10-phosphaphenanthrene 10-oxide (DOPO), triphenyl phosphate (TPP), resorcinol bis(diphenyl phosphate) (RDP), inclusive of oligomers, and also bisphenol A bis(diphenyl phosphate) (BDP) inclusive of oligomers, polyphosphonates (e.g. Nofia™ HM1100 from FRX Polymers, Chelmsford, USA), and also zinc bis(diethylphosphinate), aluminium tris(diethylphosphinate), melamine phosphate, melamine pyrophosphate, melamine polyphosphate, melamine poly(aluminium phosphate), melamine poly(zinc phosphate) and phenoxyphosphazene oligomers and mixtures of these. Particular nitrogen compounds that can be used are melamine and melamine cyanurate and reaction products of trichlorotriazine, piperazine and morpholine according to CAS No. 1078142-02-5 (e.g. MCA PPM Triazine HF from MCA Technologies GmbH, Biel-Benken, Switzerland). Preferred suitable synergists are antimony compounds, in particular antimony trioxide and antimony pentoxide, zinc compounds, tin compounds, in particular zinc stannate and borates, in particular zinc borates.

It is also possible to add, to the flame retardant, materials known as carbonizers, in particular polyphenylene ethers, and antidripping agents such as tetrafluoroethylene polymers.

Among the halogen-containing flame retardants it is particularly preferable to use ethylene-1,2-bistetrabromophthalimide, tetrabromobisphenol A oligocarbonate, polypentabromobenzyl acrylate or brominated polystyrene, in particular Firemaster® PBS64 (Great Lakes, West Lafayette, USA), in each case in combination with antimony trioxide and/or aluminium tris(diethylphosphinate).

Among the halogen-free flame retardants, it is particularly preferable to use aluminium tris(diethylphosphinate) in combination with melamine polyphosphate and/or melamine cyanurate and/or to use phenoxyphosphazene oligomers.

In particular, aluminium tris(diethylphosphinate) (CAS No. 225789-38-8) can also very particularly preferably be used as sole flame retardant.

Irrespective of component c), there can be additional fillers and/or reinforcing materials present as additives in the compositions of the invention.

However, preference is also given to use of a mixture of two or more different fillers and/or reinforcing materials, in particular based on talc, mica, silicate, quartz, titanium dioxide, wollastonite, kaolin, and to use of amorphous silicas, magnesium carbonate, chalk, feldspar, barium sulphate, glass beads and/or fibrous fillers and/or reinforcing materials based on carbon fibres. Preference is given to use of mineral particulate fillers based on mica, silicate, quartz, wollastonite, kaolin, and to use of amorphous silicas, magnesium carbonate, chalk, feldspar or barium sulphate. According to the invention, particular preference is given to use of mineral particulate fillers based on wollastonite or kaolin.

Particular preference is moreover also given to use of acicular mineral fillers as additive. According to the invention, the expression acicular mineral fillers means a mineral filler with pronounced acicular character. In particular, mention may be made of acicular wollastonites. The length:diameter ratio of the mineral is preferably about 2:1 to about 35:1, particularly preferably about 3:1 to about 19:1, most preferably about 4:1 to about 12:1. The average particle size of the acicular minerals to be used according to the invention is preferably below about 20 μm, particularly preferably below about 15 μm, with particular preference below about 10 μm, determined with a CILAS GRANULOMETER.

As already described above in relation to component c), in one preferred embodiment it is also possible that the filler and/or reinforcing material to be used as additive has been surface-modified, particularly preferably with a coupling agent or coupling agent system, with particular preference based on silane. However, the pretreatment is not essential.

The quantities used of the silane compounds for surface modification of the fillers to be used as additive are generally about 0.05 to about 2% by weight, preferably about 0.25 to about 1.5% by weight and in particular about 0.5 to about 1% by weight, based on the mineral filler.

The processing to give the moulding composition or moulding can cause the d97 value or d50 value of the particulate fillers to be smaller in the moulding composition or in the moulding than in the fillers originally used.

In one preferred embodiment, the present invention provides compositions comprising PBT, PET, triclinic-pinacoidal aluminium silicate, glass fibres and at least one phosphite stabilizer, preferably Hostanox® P-EPQ, in particular tetrakis(2,4-di-tert-butylphenyl) 1,1-biphenyl-4,4′-diylbisphosphonite, which is present in Hostanox® P-EPQ.

In one particularly preferred embodiment, the present invention provides compositions comprising PBT, PET, triclinic-pinacoidal aluminium silicate, glass fibres and at least one phosphite stabilizer, preferably Hostanox® P-EPQ, in particular tetrakis(2,4-di-tert-butylphenyl) 1,1-biphenyl-4,4′-diylbisphosphonite, which is present in Hostanox® P-EPQ, and at least one mould-release agent, preferably at least one montanic ester of polyhydric alcohols, and particularly preferably at least one ester of straight-chain, unbranched C₂₈-C₃₂ monocarboxylic acids with ethylene glycol or glycerol.

In another particularly preferred embodiment, the present invention provides compositions comprising PBT or PET, in particular blends of PBT and PET in which the PET content, based on the entirety of all of the polyesters present, is about 50 to about 99.9% by weight, glass fibres, boron nitride and titanium dioxide.

The present invention further provides, in a preferred embodiment, compositions comprising PBT or PET, in particular blends of PBT and PET in which the PET content, based on the entirety of all of the polyesters present, is about 50 to about 99.9% by weight, glass fibres, boron nitride, titanium dioxide and at least one phosphite stabilizer, preferably Hostanox® P-EPQ, in particular tetrakis(2,4-d-tert-butylphenyl) 1,1-biphenyl-4,4′-diylbisphosphonite, which is present in Hostanox® P-EPQ.

The present invention particularly preferably provides compositions comprising
a) about 24.9 to about 54% by weight of polybutylene terephthalate or polyethylene terephthalate or a blend of PBT and PET, particularly preferably a blend of PBT and PET, in particular a blend of PBT and PET in which the PET content, based on the entirety of all of the polyesters present, is about 50 to about 99.9% by weight,
b) about 21 to about 75% by weight of aluminium oxide and
c) about 0.1 to about 50% by weight of glass fibres,

with the proviso that the sum of all of the percentages by weight is always 100.

The present invention also particularly preferably provides compositions comprising
a) about 24.9 to about 54% by weight of polybutylene terephthalate or polyethylene terephthalate or a blend of PBT and PET, particularly preferably a blend of PBT and PET, in particular a blend of PBT and PET in which the PET content, based on the entirety of all of the polyesters present, is about 50 to 99.9% by weight,
b) about 21 to about 75% by weight of boron nitride,
c) about 0.1 to about 50% by weight of glass fibres, and
h) about 24.9 to about 45% by weight of titanium dioxide,

with the proviso that the sum of all of the percentages by weight is always 100.

Use

However, the present invention also provides the use of the compositions of the invention in the form of moulding compositions for the production of products with high glow-wire resistance, preferably electrical and electronic modules and components, with particular preference devices for domestic use.

The moulding compositions to be used according to the invention for injection moulding or for extrusion are obtained by mixing the individual components of the compositions of the invention in a mixer, discharging the same through at least one mixer outlet to give a strand, cooling the mixture until it is pelletizable and pelletizing the mixture.

It is preferable that the mixing in the mixer takes place in the melt at temperatures of about 285 to about 310° C. It is preferable to use an extruder as mixer, particularly a twin-screw extruder. In one embodiment, the pellets comprising the composition of the invention are dried for about 2 h at about 120° C. in a vacuum drying oven before they are subjected to injection moulding or to an extrusion process in order to produce products.

Process

However, the present invention also provides a process for the production of products, preferably of products with improved glow-wire resistance for the electrical or electronics industry, particularly preferably electronic or electrical modules and components, very particularly preferably devices for domestic use, in that the stated quantities of the individual components are mixed in a mixer, discharged through at least one mixer outlet to give a strand, cooled until pelletizable and pelletized, and the pellets are subjected to injection moulding or to an extrusion process.

However, the present invention also provides a process for improving the glow-wire resistance of polyester-based products, characterized in that compositions of the invention in the form of moulding compositions are processed by injection moulding or extrusion.

The processes of injection moulding, and also of extrusion of thermoplastic moulding compositions, are known to the person skilled in the art. Processes of the invention for the production of products by extrusion or injection moulding are carried out at melt temperatures of about 230 to about 330° C., preferably about 250 to about 300° C., and also optionally additionally at pressures of at most about 2500 bar, preferably at pressures of at most about 2000 bar, particularly preferably at pressures of at most about 1500 bar and very particularly preferably at pressures of at most about 750 bar.

In the case of sequential coextrusion, which is a type of extrusion, two different materials are discharged in alternating succession. This gives a preform with sections of different material composition in the direction of extrusion. By appropriate selection of material it is possible to equip certain sections of an item with specifically required properties, for example for items with soft ends and hard central section or integrated soft folding-bellows regions (Thielen, Hartwig, Gust, “Blasformen von Kunststoffhohlkörpern” [Blow Moulding of Hollow Plastics Products], Carl Hanser Verlag, Munich 2006, pp. 127-129).

A feature of the injection moulding process is that the raw material, preferably in pellet form, is melted (plastified) in a heated cylindrical cavity and is injected in the form of injection melt under pressure within a temperature-controlled cavity. Once the melt has cooled (solidified), the injection moulding is demoulded.

The various stages are

1. plastification/melting

2. Injection phase (charging procedure)

3. hold-pressure phase (to take account of thermal contraction during crystallization) and

4. demoulding.

An injection moulding machine is composed of a clamping unit, the injection unit, the drive and the control system. The clamping unit has fixed and movable platens for the mould, an end platen, and also tie bars and drive for the movable mould platen (toggle assembly or hydraulic clamping unit).

An injection unit encompasses the electrically heatable cylinder, the screw drive (motor, gearbox) and the hydraulic system for displacing the screw and injection unit. The function of the injection unit consists in melting, metering and injecting the powder or the pellets comprising the composition according to the Invention and applying hold pressure thereto (to take account of contraction). The problem of reverse flow of the melt within the screw (leakage flow) is solved via non-return valves.

Within the injection mould, the inflowing melt is then separated and cooled, and the required product is thus manufactured. Two mould halves are always needed for this process. Various functional systems within the injection moulding process are as follows:
runner system
shaping inserts
venting
machine mounting and uptake of force
demoulding system and transmission of motion
temperature control.

In contrast to the injection moulding process, the extrusion process uses a continuously shaped strand of plastic comprising the composition according to the invention in the extruder, where the extruder is a machine for producing thermoplastic mouldings. Various types of equipment are
single-screw extruders and twin-screw extruders and the respective subgroups
conventional single-screw extruders, conveying single-screw extruders,
contrarotating twin-screw extruders and corotating twin-screw extruders.

Extrusion plants are composed of extruder, die, downstream equipment, and extrusion blow moulds. Extrusion plants for producing profiles are composed of: extruder, profile die, calibrator, cooling section, caterpillar and roller take-off, separation device and tilting chute.

The present invention finally also provides products, in particular glow-wire-resistant products, obtainable by extrusion or injection moulding of the compositions of the invention.

It will be understood that the specification and examples are illustrative but not limitative of the present invention and that other embodiments within the spirit and scope of the invention will suggest themselves to those skilled in the art.

### Examples

### Starting Materials

PBT:
Pocan® B1100 polybutylene terephthalate from Lanxess Deutschland GmbH, Cologne, Germany

PET:
PET V004 polyester chips from Invista, Wichita, USA

Phosphite Stabilizer:
Hostanox® P-EPQ from Clariant International Ltd., Muttenz, Switzerland

Talc Powder:
Mistron® R10 from Imerys Talc Group, Toulouse, France (Rio Tinto Group)

Mould-Release Agent:
Licowax® E from Clariant International Ltd., Muttenz, Switzerland

Glass Fibre:
CS 7967 (26/1493)D from Lanxess Deutschland GmbH, Cologne, Germany

Kyanite:
Aluminium silicate particles in triclinic-pinacoidal crystal form, Silatherm® T1360-EST, Quarzwerke GmbH, Frechen, Germany

Flame Retardants (FR)

FR 1:
Melapur® MC25 melamine cyanurate, BASF, Ludwigshafen, Germany

FR 2:
bisphenol A diphosphate (CAS No. 61261-37-8)

FR 3:
bisphenol A epoxy oligomer (CAS No. 728911-06-6)

FR 4:
80% antimony trioxide in PBT

Experimental Method:

The compositions described according to the invention were produced by mixing the Individual components in the melt in a twin-screw extruder (ZSK 26 Mega Compounder from Coperon Werner & Pfleiderer, Stuttgart, Germany, with 3-hole die plate and with die-hole diameter 3 mm) at temperatures of about 260 to about 280° C., discharging them in the form of strand, cooling until pelletizable and pelletizing. Before further steps, the pellets were dried for about 2 h at about 120° C. in a vacuum drying oven.

The sheets and test samples for the tests listed in Table 1 were injection-moulded at melt temperature of about 260° C. and mould temperature of about 80° C. in a commercially available injection-moulding machine.

GWFI Determination

Glow Wire Flammability Index (GWFI) was determined in accordance with the IEC/EN 60695-2-12 standard.

GWIT Determination

Glow Wire Ignition Temperature (GWIT) was determined in accordance with the IEC/EN 60695-2-13 standard.

Thermogravimetric Analysis (TGA)

Thermal stability, which is a decisive factor in determining processing latitude, was evaluated by thermogravimetric analysis (TGA). To this end, the sample was heated at a rate of 20.0 K/min in a vacuum-tight thermal microbalance (Netzsch TG209 F1 Iris), and the change of mass was recorded as a function of temperature. The temperature at which cumulative loss of mass was 2% was defined as temperature T(D) (=decomposition temperature) at which thermal stability had become inadequate.

TABLE 1

| | | | Com- | Com- | Com- | Com- |
|---|---|---|---|---|---|---|
| | | Inven- | parative | parative | parative | parative |
| | | tive | example | example | example | example |
| | | example | 1 | 2 | 3 | 4 |
| PBT | [%] | 5.8 | 5.8 | 5.8 | 37.8 | 28.8 |
| PET | [%] | 28.3 | 28.3 | 28.3 | 28.3 | 28.3 |
| Phosphite | [%] | 0.1 | 0.1 | 0.1 | 0.1 | 0.1 |
| stabilizer | | | | | | |
| Mould- | [%] | 0.8 | 0.8 | 0.8 | 0.8 | 0.8 |
| release | | | | | | |
| agent | | | | | | |
| Glass fibre | [%] | 15 | 15 | 15 | 15 | 15 |
| Kyanite | [%] | 50 | 0 | 0 | 0 | 0 |
| Zinc | [%] | 0 | 50 | 0 | 0 | 0 |
| sulphide | | | | | | |
| Titanium | [%] | 0 | 0 | 50 | 0 | 0 |
| dioxide | | | | | | |
| Flame | [%] | 0 | 0 | 0 | 0 | 12 |
| retardant 1 | | | | | | |
| Flame | [%] | 0 | 0 | 0 | 0 | 15 |
| retardant 2 | | | | | | |
| Flame | [%] | 0 | 0 | 0 | 12 | 0 |
| retardant 3 | | | | | | |
| Flame | [%] | 0 | 0 | 0 | 6 | 0 |
| retardant 4 | | | | | | |
| GWIT | | passed | failed | failed | — | passed |
| (1.55 mm) | | | | | | |
| 775° C. | | | | | | |
| GWFI | | passed | failed | failed | passed | — |
| (1.55 mm) | | | | | | |
| 850° C. | | | | | | |
| T(D) | [° C.] | >350 | >350 | >350 | <350 | <350 |

As can be seen from Table 1, compositions of the invention achieved not only the GWIT but also the GWFI required for unsupervised devices for domestic use in accordance with IEC 60335-1. Furthermore, 2% loss of mass was not reached until temperatures exceeded 350° C. In contrast to this, other minerals (Comparative Examples 1 and 2) did not comply with the glow-wire requirements in accordance with IEC 60335-1. With halogen-containing flame retardants (Comparative Example 3) and halogen-free flame retardants (Comparative Example 4) it was possible to achieve the required GWFI and, respectively, GWIT values. However, these materials had markedly lower T(D), and therefore less processing latitude, because of premature decomposition of the flame retardants.

What is claimed is:

1. A composition comprising:
a) at least one polyalkylene terephthalate;
b) at least one component selected from the group of aluminium oxide, boron nitride and aluminium silicate; and
c) glass fibres.

2. The composition according to claim 1, wherein the polyalkylene terephthalate comprises polybutylene terephthalate (PBT), polyethylene terephthalate (PET) or a blend of PBT and PET.

3. The composition according to claim 2, wherein the polyalkylene terephthalate comprises the blend of PBT and PET, and the blend has a PET content of 50 to 99.9% by weight, based on the entirety of all of the polyesters present.

4. The composition according to claim 1, wherein the at least one component is aluminium silicate.

5. The composition according to claim 4, wherein the aluminium silicate has a triclinic-pinacoidal crystal structure.

6. The composition according to claim 1, wherein the composition comprises:
a) 24.9 to 89.9% by weight of the at least one polyalkylene terephthalate;
b) 10 to 75% by weight of the at least one component; and
c) 0.1 to 50% by weight of the glass fibres,
with the proviso that the sum of all of the percentages by weight is always 100.

7. The composition according to claim 6, wherein, in addition to components a), b) and c) the composition further comprises:
d) 0.01 to 5% by weight, based on the entire composition, of at least one phosphite stabilizer, and
the amount of at least one of components a), b), and c) is reduced to an extent such that the sum of all of the percentages by weight is always 100.

8. The composition according to claim 7, wherein, in addition to component d), or instead of d), the composition further comprises:
e) 0.01 to 10% by weight, based on the entire composition, of at least one flow auxiliary, and
the amount of at least one of the other components is reduced to an extent such that the sum of all of the percentages by weight is always 100.

9. The composition according to claim 8, wherein in addition to component d) and e), or instead of d) and/or e), the composition further comprises:
f) 0.01 to 15% by weight, based on the entire composition, of talc powder, and
the amount of at least one of the other components is reduced to an extent such that the sum of all of the percentages by weight is always 100.

10. The composition according to claim 9 wherein the talc powder is microcrystalline talc powder.

11. The composition according to claim 9, wherein in addition to components d), e), and f), or instead of d) and/or e) and/or f), the composition further comprises:
g) 0.01 to 15% by weight, based on the entire composition, of at least one mould-release agent, and
the amount of at least one of the other components is reduced to an extent such that the sum of all of the percentages by weight is always 100.

12. The composition according to claim 11, wherein in addition to components d), e), f) and g), or instead of components d) and/or e) and/or f) and/or g), the composition further comprises:
h) 0.01 to 45% by weight, based on the entire composition, of at least one other additive different from components c), d), e), f) and g), and
the amount of at least one of the other components is reduced to an extent such that the sum of all of the percentages by weight is always 100.

13. The composition according to claim 7, wherein the phosphite stabilizer comprises a phosphite stabilizer selected from the group of tris(2,4-di-tert-butylphenyl)phosphite, bis(2,4-di-tert-butylphenyl)pentaerythritol diphosphite, bis(2,6-di-tert-butyl-4-methylphenyl)pentaerythrtol diphosphite, bis(2,4-dicumylphenyl)pentaerythritol diphosphite, tris(nonylphenyl)phosphite, (2,4,6-tri-tert-butylphenol) 2-butyl-2-ethyl-1,3-propanediol phosphite, and Hostanox® P-EPQ where the latter comprises tetrakis(2,4-di-tert-butylphenyl) 1,1-biphenyl-4,4′-diylbisphosphonite.

14. The composition according to claim 11, wherein the mould-release agent comprises at least one mould release agent selected from the group of ester waxes, pentaerythritol tetrastearate (PETS), long-chain fatty adds, salts of long-chain fatty acids, amide derivatives of long-chain fatty adds, montan waxes, low-molecular-weight polyethylene waxes, low-molecular-weight polypropylene waxes and ethylene homopolymer waxes.

15. The composition according to claim 11, wherein the mould-release agent comprises at least one montan ester of a polyhydric alcohol.

16. The composition according to claim 11, wherein the mould-release agent comprises an ester of straight-chain, unbranched C₂₈-C₃₂ monocarboxylic acids with ethylene glycol or glycerol.

17. A method for producing products with high glow-wire resistance from the composition according to claim 1, the method comprising forming moulding of the composition by injection moulding or extrusion.

18. The method according to claim 17, further comprising conducting the injection moulding or extrusion at melt temperatures of 230 to 330° C.

19. The method according to claim 17, wherein the products are electrical and electronic modules and components.

20. A process for the production of products, the process comprising mixing the individual components of the composition according to claim 6 in a mixer, discharging the mixture through at least one mixer outlet to give a strand, cooling the strand until pelletizable, pelletizing the strand, and injection moulding or extrusion the pellets.

21. The process according to claim 20, wherein the mixing takes place in a melt at temperatures of 285 to 310° C.
